(19) United States
(12) Patent Application Publication
(10) Pub. No.: US 2021/0207970 A1
(43) Pub. Date: Jul. 8, 2021

(54) NAVIGATION DEVICE AND ROUTE GUIDANCE METHOD

(71) Applicant: TOYOTA JIDOSHA KABUSHIKI KAISHA, Toyota-shi (JP)

(72) Inventors: Ayano ASAI, Anjo-shi (JP); Takashi HARAYAMA, Toyota-shi (JP); Koji TERASHIMA, Nagoya-shi (JP); Shigeaki MURATA, Nisshin-shi (JP); Takahiko HASEGAWA, Toyota-shi (JP); Tomio YAMANAKA, Nagoya-shi (JP); Syun YOSHIDA, Nagoya-shi (JP)

(73) Assignee: TOYOTA JIDOSHA KABUSHIKI KAISHA, Toyota-shi (JP)

(21) Appl. No.: 17/134,939

(22) Filed: Dec. 28, 2020

(30) Foreign Application Priority Data
Jan. 6, 2020 (JP) 2020-000341

(51) Int. Cl. G01C 21/34; G01C 21/36

(52) U.S. Cl. CPC G01C 21/3469; G01C 21/3679; G01C 21/3697

(57) ABSTRACT

A navigation device includes: a drivable distance acquisition portion that acquires a drivable distance over which a fuel cell vehicle is able to drive without being replenished with hydrogen gas; a hydrogen station identification portion that identifies a hydrogen station present within a drivable range; a route setting portion that sets a target route and that changes, when the distance of a first route set according to a predetermined condition is longer than the drivable distance, the target route to a second route that passes through a specific hydrogen station and that is different from the first route; and a performance requirement transmission portion that transmits, to the specific hydrogen station, through a communication portion mounted on the fuel cell vehicle, a performance requirement of pre-processing for charging the hydrogen gas into a hydrogen gas storage portion included in the fuel cell vehicle.

### CROSS REFERENCE TO RELATED APPLICATIONS

This application claims priority based on Japanese Patent Application No. 2020-341 filed on Jan. 6, 2020 the entire disclosure of which is hereby incorporated by reference.

### BACKGROUND

### Field

The present disclosure relates to navigation devices.

### Related Art

As a navigation device which is mounted on a vehicle using gasoline as a fuel (hereinafter referred to as a “gasoline vehicle”), a navigation device is proposed that determines, as with a navigation device disclosed in Japanese Unexamined Patent Application Publication No. 2013-96871, whether or not a destination is able to be reached without refueling, and that sets and guides, when it is determined that the destination is not able to be reached without refueling, a route along which the destination is reached through a gas station satisfying preset conditions under which the gas station is passed through.

The navigation device disclosed in Japanese Unexamined Patent Application Publication No. 2013-96871 is only assumed to be mounted on a gasoline vehicle, and consideration is not given to mounting on a fuel cell vehicle which uses hydrogen gas as a fuel. The charging of hydrogen gas into a fuel cell vehicle is performed in a hydrogen station which stores a large amount of hydrogen gas and in which a dispenser is provided. In general, in the hydrogen station, hydrogen gas which is previously compressed to a high pressure of, for example, about 80 MPa is stored, and is rapidly charged into a tank mounted on a fuel cell vehicle. Here, in order to prevent the temperature of the tank from being increased to a high temperature, so-called pre-cooling processing which cools the hydrogen gas to be charged to a low temperature of, for example, −40° C. is needed, and the hydrogen station significantly differs from a gas station in this point.

In general, the pre-cooling processing is processing in which heat exchange is performed between a cooling medium such as brine or ethylene glycol and hydrogen gas, and pre-processing is needed which previously cools the cooling medium with a refrigerator or the like to a predetermined temperature. It takes a long time to cool the cooling medium such that the pre-cooling processing is able to be performed. Hence, even when the navigation device as disclosed in patent literature 1 is utilized so as to set a route along which a destination is reached through a hydrogen station, and then the hydrogen station is reached according to the guidance of the route, since the pre-processing is thereafter performed and hydrogen gas is charged after the completion of the pre-processing, it disadvantageously takes a long time to start the charging of the hydrogen gas. In this case, the destination is reached extremely late. In a configuration in which liquid hydrogen is stored as hydrogen in a hydrogen station and in which hydrogen gas is obtained by vaporizing the liquid hydrogen, the vaporization processing of the liquid hydrogen is performed as the pre-processing, with the result that the same problem may occur. Hence, a technology is desired which is able to reduce the time necessary until the charging of hydrogen gas is started in a hydrogen station.

### SUMMARY

The present disclosure is able to be realized as an aspect below.

According to one aspect of the present disclosure, a navigation device is provided that is mounted on a fuel cell vehicle including a fuel cell which uses hydrogen gas as a fuel gas and is used and that performs route guidance for the fuel cell vehicle. The navigation device includes: a drivable distance acquisition portion configured to acquire a drivable distance over which the fuel cell vehicle is able to drive without being replenished with the hydrogen gas; a hydrogen station identification portion configured to identify a hydrogen station present within a drivable range that is a range from a present location to the drivable distance; a route setting portion configured to set a target route that is a route from the present location to a destination and to change, when the distance of a first route which is the target route set according to a predetermined condition is longer than the drivable distance, the target route to a second route which passes through a specific hydrogen station serving as the identified hydrogen station and that is different from the first route; and a performance requirement transmission portion configured to transmit, to the specific hydrogen station, through a communication portion mounted on the fuel cell vehicle, a performance requirement of pre-processing for charging the hydrogen gas into a hydrogen gas storage portion included in the fuel cell vehicle.

### BRIEF DESCRIPTION OF THE DRAWINGS

FIG. 1 is a block diagram showing a schematic configuration of a navigation device according to an embodiment of the present disclosure;

FIG. 2 is an illustrative view schematically showing an example of a target route;

FIG. 3 is a block diagram showing a schematic configuration of a first hydrogen station;

FIG. 4 is a flowchart showing a procedure for hydrogen gas charging reservation processing;

FIG. 5 is a block diagram showing a schematic configuration of a navigation device according to a second embodiment;

FIG. 6 is a flowchart showing a procedure for hydrogen gas charging reservation processing in the second embodiment;

FIG. 7 is a flowchart showing a procedure for the hydrogen gas charging reservation processing in the second embodiment; and

FIG. 8 is an illustrative view showing an example of a hydrogen station selection screen.

### DETAILED DESCRIPTION

### A. First Embodiment

A1. Device Configuration:

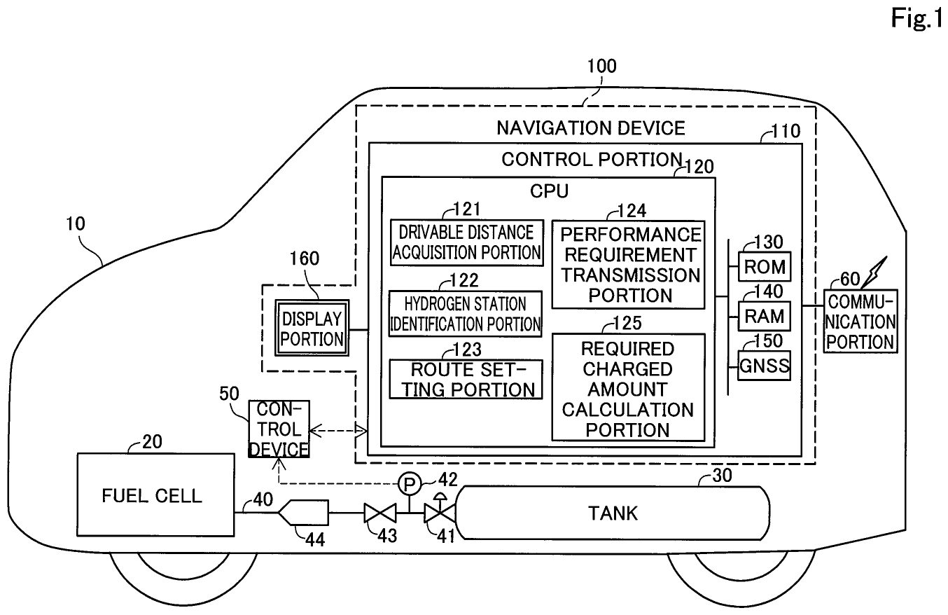

FIG. 1 is a block diagram showing a schematic configuration of a navigation device 100 according to an embodiment of the present disclosure. The navigation device 100 is mounted on a fuel cell vehicle 10 and is used, and performs the setting of a route of the fuel cell vehicle 10 and route guidance. The configuration of the fuel cell vehicle 10 will first be described.

The fuel cell vehicle 10 includes a fuel cell 20 as the power source of an unillustrated traction motor. The fuel cell 20 includes a fuel cell stack where a large number of power generation elements which are called unit cells and each of which is able to generate power are stacked in layers. In the present embodiment, the fuel cell 20 is a solid polymer fuel cell, hydrogen gas is used as a fuel gas and air is used as an oxidizing gas. The fuel cell vehicle 10 includes, in addition to the fuel cell 20, a tank 30 in which the hydrogen gas is stored, a hydrogen gas supply path 40 which supplies the hydrogen gas from the tank 30 to the fuel cell 20, a main stop valve 41, a pressure sensor 42, a regulator 43, an injector 44, a control device 50 and a communication portion 60.

The tank 30 stores the high-pressure hydrogen gas. In the present embodiment, the tank 30 is able to store about 5 kg (kilogram) of the hydrogen gas. The tank 30 is configured to be able to store the hydrogen gas of 80 MPa. The amount of hydrogen gas which is able to be stored in the tank 30 and the pressure of the hydrogen gas which is stored are not limited to these values. The tank 30 corresponds to a hydrogen gas storage portion in the present disclosure. The main stop valve 41 is configured with an open/dose valve, and distributes, in an open valve state, the hydrogen gas to the downstream side of the hydrogen gas supply path 40. The pressure sensor 42 is arranged between the main stop valve 41 and the regulator 43 in the hydrogen gas supply path 40, and detects the pressure of the hydrogen gas supply path 40 in the corresponding position. When the main stop valve 41 is in an open state, the pressure detected with the pressure sensor 42 is substantially equal to a pressure within the tank 30. The regulator 43 reduces the pressure of the hydrogen gas to a predetermined pressure, and supplies the hydrogen gas to the injector 44. The injector 44 is located between the regulator 43 and the fuel cell 20 in the hydrogen gas supply path 40. The injector 44 is one type of open/dose valve, and is an injection device which adjusts, according to a ratio (duty) of an open valve time per unit time, the amount of hydrogen gas supplied to the fuel cell 20.

The control device 50 controls various devices which configure a fuel cell system including the fuel cell 20. For example, the control device 50 controls various types of devices which configure a fuel gas supply system including the main stop valve 41, the regulator 43 and the injector 44 described above, a fuel gas exhaust system, an oxidizing gas supply system, an oxidizing gas exhaust system and a cooling medium circulation system. Here, the fuel cell 20 acquires the detection values of various types of sensors including the pressure sensor 42 and utilizes the acquired detection values so as to perform the control. In the present embodiment, the control device 50 is configured with an ECU (Electronic Control Unit). The control device 50 utilizes the detection value of the pressure sensor 42 so as to identify the pressure within the tank 30. Since the pressure within the tank 30 correlates with the remaining amount of hydrogen in the tank 30, the control device 50 utilizes the pressure so as to be able to identify the remaining amount of hydrogen. The remaining amount of hydrogen may be identified, for example, by previously storing, in a ROM included in the control device 50, a map in which the pressure within the tank 30 is associated with the remaining amount of hydrogen and referencing the map. The remaining amount of hydrogen may also be identified, for example, by previously determining a computation formula indicating a relationship between the pressure and the remaining amount of hydrogen, applying a pressure value to the computation formula and thereby calculating the remaining amount of hydrogen. The control device 50 calculates, based on the identified remaining amount of hydrogen, the drivable distance of the fuel cell vehicle 10. The “drivable distance” means a distance over which the fuel cell vehicle 10 is able to drive without being replenished with hydrogen gas. For example, the control device 50 calculates the drivable distance based on the remaining amount of hydrogen from an average vehicle speed and the amount of hydrogen consumed after the startup of the fuel cell vehicle 10 until now. The control device 50 repeatedly calculates the drivable distance together with the startup of the fuel cell vehicle 10.

The communication portion 60 performs wireless communication. In the present embodiment, the communication portion 60 performs 4G (4th Generation) communication. Instead of the 4G communication, the communication portion 60 may perform any other type of wireless communication such as mobile communication provided by a telecommunication carrier like LTE (Long Time Evolution) communication or 5G (5th Generation) communication or a wireless LAN (Local Area Network).

The navigation device 100 includes a control portion 110 and a display portion 160. The control portion 110 controls the entire navigation device 100. In the present embodiment, the control portion 110 is configured with a computer which includes a CPU 120, a ROM 130, a RAM 140 and a GNSS function portion 150. The CPU 120 reads a control program stored in the ROM 130, loads it into the RAM 140 and executes it, and thereby functions as a drivable distance acquisition portion 121, a hydrogen station identification portion 122, a route setting portion 123, a performance requirement transmission portion 124 and a required charged amount calculation portion 125.

The drivable distance acquisition portion 121 acquires the drivable distance from the control device 50. As described previously, in the control device 50, the drivable distance is repeatedly calculated.

The hydrogen station identification portion 122 identifies, in hydrogen gas charging reservation processing which will be described later, a hydrogen station which is present within the range of the drivable distance (hereinafter referred to as the “drivable range”).

The route setting portion 123 sets the target route of the fuel cell vehicle 10. The target route means a route that is set as a route along which the fuel cell vehicle 10 drives up to a destination G. In the present embodiment, the route setting portion 123 displays a menu screen for route setting on the display portion 160, and searches for and sets, when a user sets the destination on the menu screen, a route from the present location of the fuel cell vehicle 10 to the destination according to a predetermined algorithm. In the present embodiment, the “predetermined algorithm” described above is an algorithm such as Dijkstra's method which determines the shortest distance.

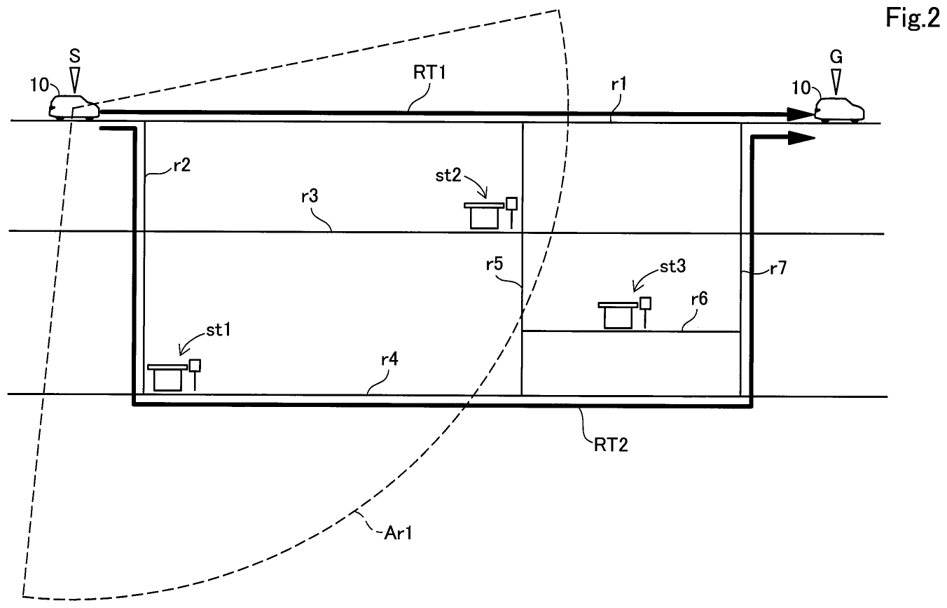

FIG. 2 is an illustrative view schematically showing an example of the target route which is set with the route setting portion 123. In the example of FIG. 2, between the present location S of the fuel cell vehicle 10 and the destination G, a plurality of roads r1 to r7, three hydrogen stations (a first hydrogen station st1, a second hydrogen station st2 and a third hydrogen station st3) are present. The road r1 is a road on which both the present location S and the destination G are present. The roads r3 and r4 are roads which are parallel to the road r1. The roads r2, r5 and r7 are roads each of which intersects the roads r1, r3 and r4. The road r6 is a road which connects the road r5 and the road r7 together, and which is parallel to the road r1. The first hydrogen station st1 is present at an intersection between the road r2 and the road r4. The second hydrogen station st2 is present at an intersection between the road r3 and the road r5. The third hydrogen station st3 is present along the road r6. When distances from the present location S to the individual hydrogen stations st1 to st3 are compared with each other, the distance up to the first hydrogen station st1 is the shortest, the distance up to the second hydrogen station st2 is the second shortest and the distance up to the third hydrogen station st3 is the third shortest. The distance means a distance along the road.

In the example shown in FIG. 2, the route setting portion 123 sets, as the target route of the fuel cell vehicle 10, a route RT1 which is indicated by a thick solid-line arrow. This is because the route RT1 is a route which linearly extends along the single road r1 without being turned at an intersection halfway through the route RT1 and is the shortest road. In the hydrogen gas charging reservation processing which will be described later, the target route is changed from the route RT1 to a route RT2 which is indicated by a thick solid-line arrow. The details of the change of the target route will be described later.

As the search algorithm of the target route in the route setting portion 123, instead of the algorithm for determining the shortest distance or in addition to the algorithm, any other type of algorithm such as an algorithm for determining a route along which the destination is reached in the shortest time or an algorithm for determining a route in which the cost is the lowest may be used with consideration given to a driving time zone, a toll road and the like.

In the hydrogen gas charging reservation processing which will be described later, the performance requirement transmission portion 124 shown in FIG. 1 transmits a pre-processing performance requirement to the hydrogen station. The details of the pre-processing performance requirement will be described later. The required charged amount calculation portion 125 calculates a required charged amount. The required charged amount means the amount of hydrogen gas which is required to be charged in the hydrogen station. The details of a method of calculating the required charged amount will be described later.

In the ROM 130, in addition to the control program described above, map information is previously stored. The map information includes not only information of the positions, the sizes and the like of roads and intersections but also the sizes, the types and the like of buildings. Hence, information on the hydrogen stations st1 to st3 as shown in FIG. 2 is also included in the map information. As the information on the hydrogen stations st1 to st3 included in the map information, for example, the names of the individual hydrogen stations, that is, the “first hydrogen station”, the “second hydrogen station” and the “third hydrogen station”, the position information of the individual hydrogen stations and information on the outlines and sizes of sites and buildings apply.

The GNSS function portion 150 utilizes a GNSS (Global Navigation Satellite System) so as to identify the present location (latitude and longitude) of the fuel cell vehicle 10. Although in the present embodiment, as the GNSS, the GPS (Global Positioning System) is used, the GNSS is not limited to the GPS, and any other type of GNSS such as Galileo or QZSS may be used.

The display portion 160 displays not only the map information but also various types of menu screens, messages and the like. In the present embodiment, the display portion 160 is configured with a touch panel so as to receive an operation from the user.

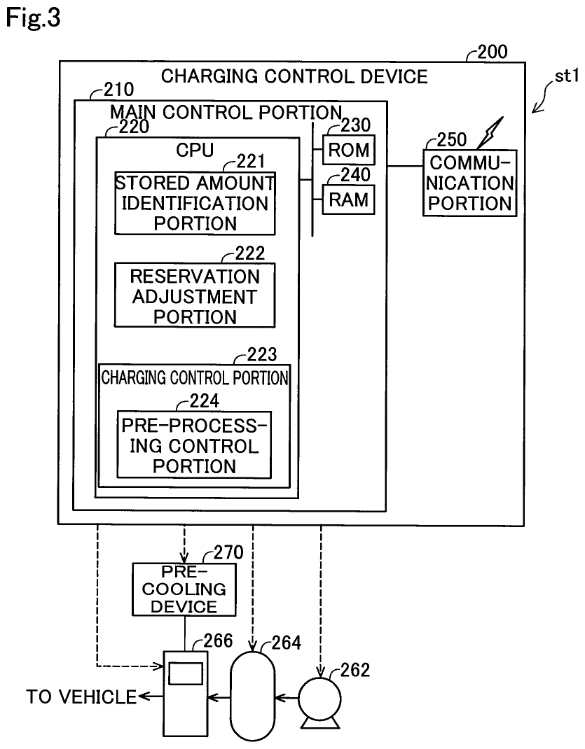

FIG. 3 is a block diagram showing a schematic configuration of the first hydrogen station st1. In the present embodiment, each of the hydrogen stations st1 to st3 shown in FIG. 2 has substantially the same configuration. Hence, the first hydrogen station st1 will be described as a representative.

The first hydrogen station st1 stores hydrogen in the form of hydrogen gas, and charges the stored hydrogen gas into the vehicle. The first hydrogen station st1 includes a charging control device 200, a compressor 262, an accumulator 264, a dispenser 266 and a pre-cooling device 270.

The charging control device 200 performs various types of control on the charging of the hydrogen gas into the vehicle. In the present embodiment, the charging control device 200 includes a main control portion 210 and a communication portion 250. The main control portion 210 is configured with a computer which includes a CPU 220, a ROM 230 and a RAM 240. The CPU 220 executes a control program stored in the ROM 230 so as to function as a stored amount identification portion 221, a reservation adjustment portion 222 and a charging control portion 223.

The stored amount identification portion 221 identifies the amount of hydrogen gas stored in the accumulator 264. An unillustrated pressure sensor which detects a pressure within the accumulator 264 is connected to the accumulator 264. The stored amount identification portion 221 utilizes the detection value of the pressure sensor so as to identify the amount of hydrogen gas stored in the accumulator 264.

The reservation adjustment portion 222 adjusts and manages charging reservations for hydrogen gas in the first hydrogen station st1. Specifically, the reservation adjustment portion 222 receives, through the communication portion 250, a reservation for charging hydrogen gas which is transmitted from the vehicle, makes a reservation if possible and provides, to the vehicle, a replay as to whether or not the reservation is made. When the reservation is made, the reservation adjustment portion 222 instructs the charging control portion 223 to perform the pre-processing.

The charging control portion 223 controls the compressor 262, the accumulator 264, the dispenser 266 and the pre-cooling device 270 so as to control the charging of the hydrogen gas into the vehicle. The charging control portion 223 includes a pre-processing control portion 224. The pre-processing control portion 224 controls the performance of the pre-processing. In the present embodiment, the “pre-processing” means processing for bringing the pre-cooling processing of the hydrogen gas utilizing the pre-cooling device 270 into a state where the pre-cooling processing is able to be performed. When the high-pressure hydrogen gas is rapidly charged into the tank 30 of the vehicle 10, the temperature of the tank 30 may be rapidly increased by adiabatic compression so as to reach a high temperature exceeding, for example, 85° C. Hence, when the hydrogen gas is supplied from the dispenser 266, the so-called pre-cooling processing is performed which cools the hydrogen gas to, for example, about −40° C. A time necessary for bring the pre-cooling processing into the state where the pre-cooling processing is able to be performed, that is, a time necessary for the pre-processing is longer than a hydrogen charging time for one vehicle. The details of the pre-cooling processing and the pre-processing will be described later.

The communication portion 250 performs wireless communication. In the present embodiment, the communication portion 250 performs 4G communication as with the above-described communication portion 60 included in the fuel cell vehicle 10. The communication portion 250 and the communication portion 60 are able to exchange data with each other by 4G communication.

The compressor 262 compresses hydrogen gas which is transported with a tank lorry or the like to the first hydrogen station st1, and feeds the hydrogen gas out to the accumulator 264. For example, the compressor 262 increases the pressure of the hydrogen gas to 45 MPa or 80 MPa and then supplies the hydrogen gas to the accumulator 264. A configuration may be adopted in which a plurality of compressors 262 are provided so as to compress the hydrogen gas in multiple stages.

The accumulator 264 stores the compressed hydrogen gas which is supplied from the compressor 262. The dispenser 266 includes an unillustrated nozzle having such a shape that the nozzle is able to be connected to a receptacle provided in the hydrogen gas inlet of the vehicle, and supplies the hydrogen gas from the nozzle to the vehicle. The hydrogen gas supplied here is the hydrogen gas which is stored in the accumulator 264 and on which the pre-cooling processing has been performed.

The pre-cooling device 270 cools the hydrogen gas when the hydrogen gas stored in the accumulator 264 is supplied from the compressor 262. In the present embodiment, the pre-cooling device 270 is configured as a cooling system of a refrigerator type, includes a refrigerator and a brine circuit and utilizes brine cooled with the refrigerator so as to cool the hydrogen gas. The refrigerator includes a vaporization portion which vaporizes the cooling medium, a compression portion which compresses the cooling medium that flows out from the vaporization portion, a condensation portion which air-cools and condenses the compressed cooling medium and an expansion portion which expands the cooling medium that flows out from the condensation portion, and configures a so-called heat pump cycle. The brine circuit includes a circulation flow path for the brine, a brine circulation pump which is provided in the circulation flow path and a heat exchange portion which exchanges heat with the vaporization portion of the refrigerator. The brine circuit is a system whose time constant is large. In other words, in the brine circuit, it takes a long time until the system is cooled to a predetermined temperature such that the temperature of the brine is stabilized. Hence, it is necessary to operate the refrigerator and the brine circuit a considerable time before the hydrogen gas is charged. Thus, in the pre-cooling device 270, under control of the pre-processing control portion 224, as the pre-processing, the refrigerator and the brine circuit are operated.

A2. Hydrogen Gas Charging Reservation Processing:

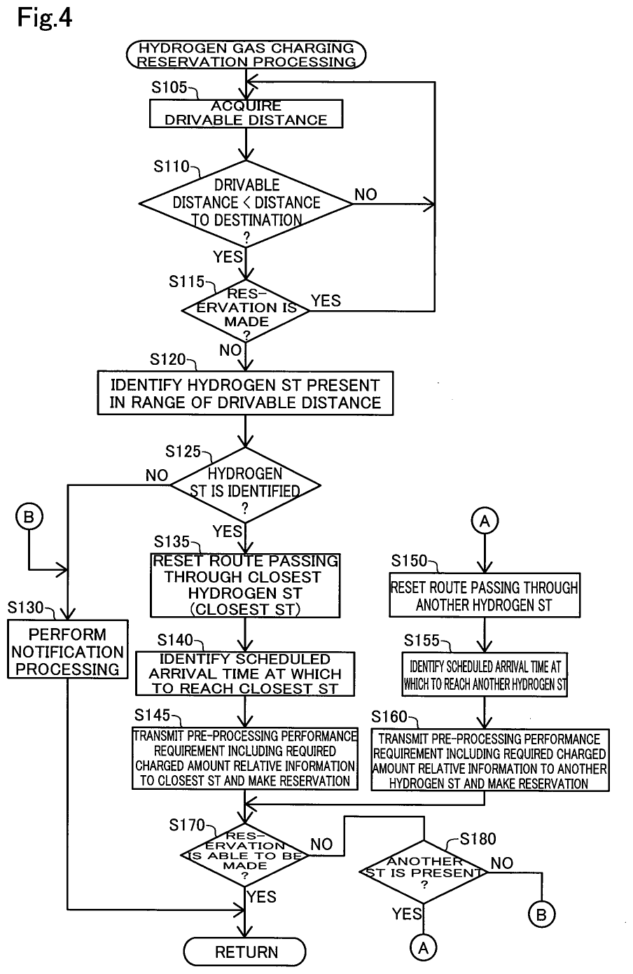

FIG. 4 is a flowchart showing a procedure for the hydrogen gas charging reservation processing. The hydrogen gas charging reservation processing means processing for reserving the charging of the hydrogen gas into the tank 30 for the hydrogen station. When the target route is set in the fuel cell vehicle 10, the hydrogen gas charging reservation processing is performed.

In step S105, the drivable distance acquisition portion 121 acquires the drivable distance. As described previously, the control device 50 calculates the drivable distance of the fuel cell vehicle 10 from the remaining amount of hydrogen in the tank 30. Hence, in step S105, the drivable distance acquisition portion 121 acquires the drivable distance calculated with the control device 50.

In step S110, the drivable distance acquisition portion 121 determines whether or not the drivable distance acquired in step S105 is smaller than a distance up to the destination G. When it is determined that the drivable distance is not smaller than the distance up to the destination G (step S110: no), the processing is returned to step S105 described above. On the other hand, when it is determined that the drivable distance is smaller than the distance up to the destination G (step S110: yes), in step S115, the hydrogen station identification portion 122 determines whether or not hydrogen gas charging has already been reserved for any hydrogen station. When step S145 or step S160 which will be described later is performed, a reservation has already been made. When it is determined that a reservation has been made (step S115: yes), the processing is returned to step S105 described above.

When it is determined that a reservation has not been made (step S115: no), in step S120, the hydrogen station identification portion 122 identifies a hydrogen station which is present within the range of the drivable distance. In the example of FIG. 2, as the hydrogen station which is present within the range Ar1 of the drivable distance, the first hydrogen station st1 and the second hydrogen station st2 are identified. In the present embodiment, as shown in FIG. 2, the hydrogen stations are simply identified which are present within a circular region that has the drivable distance as a radius with the present location S being the center thereof. A range in which a distance along each of the roads is equal to or less than the drivable distance may be set to the “range of the drivable distance”, and thus a hydrogen station which is present within such a range may be identified. In step S120, the hydrogen station which is identified is also referred to as the “specific hydrogen station”.

As shown in FIG. 4, in step S125, the route setting portion 123 determines whether or not a hydrogen station is identified in step S120. When it is determined that a hydrogen station is not identified (step 125: no), in step S130, the route setting portion 123 performs notification processing which provides notification that the occurrence of a shortage of the hydrogen gas is predicted. In a case where step S125 is performed, since the drivable distance is shorter than the distance up to the destination G, when the fuel cell vehicle 10 drives along the route RT1 without being replenished, a shortage of the hydrogen gas occurs halfway through the route RT1. When no hydrogen station is present within the range of the drivable distance, it is impossible to drive toward the destination G by charging the hydrogen gas. As will be described later, even if a hydrogen station is present within the drivable range, when it is impossible to make a reservation for the specific hydrogen station, it is impossible to drive toward the destination G by charging the hydrogen gas. Hence, in this case, the route setting portion 123 provides notification that the occurrence of a shortage of the hydrogen gas is predicted, and thus the user is encouraged to pay attention. Examples of the notification in step S130 include the display of a warning message on the display portion 160, the output of a warning message or a warning sound from an unillustrated speaker and the like. The user who receives the notification described above is able to cope with this problem such as by stopping the fuel cell vehicle 10 in a safe place. After the completion of step S130, the processing is returned to step S105.

When in step S125 described above, it is determined that a hydrogen station is identified (step S125: yes), in step S135, the route setting portion 123 resets, as the target route of the fuel cell vehicle 10, a route which passes through a hydrogen station closest to the present location S (hereinafter referred to as the “closest station”) among specific hydrogen stations. In step S135, a hydrogen station on the route along which the fuel cell vehicle 10 has driven up to the present location S and a hydrogen station which is located in a direction opposite to a direction toward the destination G may be omitted. In the example of FIG. 2, the two hydrogen stations st1 and st2 are identified, and of these two hydrogen stations, the first hydrogen station st1 which is the closest from the present location S applies as the closest station. Hence, the route along which the destination G is reached through the first hydrogen station st1 is reset. Thus, in the example of FIG. 2, the target route of the fuel cell vehicle 10 is changed from the route RT1 to the route RT2. Both a route from the present location S to the first hydrogen station st1 and a route from the first hydrogen station st1 to the destination G are searched for with the predetermined algorithm described above. The route RT1 corresponds to a first route in the present disclosure, and the route RT2 corresponds to a second route in the present disclosure.

As shown in FIG. 4, in step S140, the route setting portion 123 identifies a scheduled arrival time at which the closest station identified in step S135 is reached. In the present embodiment, the route setting portion 123 identifies, base on the map information, a distance from the present location S to the closest station, identifies an average vehicle speed after the startup of the fuel cell vehicle 10 until now, uses these identified values so as to calculate an estimated required time from the present location S to the first hydrogen station st1, adds it to the current time and thereby identifies the scheduled arrival time.

In step S145, the performance requirement transmission portion 124 transmits the pre-processing performance requirement including required charged amount relative information and the scheduled arrival time through the communication portion 60 to the closest station, and thereby reserves the charging of the hydrogen gas. The pre-processing performance requirement means a requirement for performing the pre-processing. The required charged amount relative information means information related to the required charged amount of hydrogen gas which is charged in the closest station. In the present embodiment, the required charged amount relative information includes the required charged amount. In the present embodiment, the required charged amount is calculated as follows with the required charged amount calculation portion 125. Specifically, the amount of hydrogen gas obtained by adding a predetermined additional gas amount to a difference between the amount of hydrogen gas obtained by subtracting the amount of hydrogen gas estimated to be required from the present location S to the first hydrogen station st1 from the current remaining amount of hydrogen gas in the tank 30 and the amount of hydrogen gas estimated to be required for driving from the first hydrogen station st1 to the destination G is calculated as the required charged amount. The additional gas amount is previously set to, for example, the amount of hydrogen gas with which the fuel cell vehicle 10 is able to drive an additional distance of 50 km. The additional gas amount is not limited to the value described above, and an arbitrary amount of hydrogen gas may be set to the additional gas amount. When the amount of hydrogen gas obtained by subtracting the amount of hydrogen gas estimated to be required from the present location S to the first hydrogen station st1 from the current remaining amount of hydrogen gas in the tank 30 is large, that is, the estimated empty capacity of the tank 30 at the time of arrival at the first hydrogen station st1 is low, and thus it is predicted that the amount of hydrogen gas corresponding to the required charged amount is not able to be charged into the tank 30, a difference between the charging upper limit value of the tank 30 and the amount of hydrogen gas obtained by subtracting the amount of hydrogen gas estimated to be required from the present location S to the first hydrogen station st1 from the current remaining amount of hydrogen gas in the tank 30 is calculated as the required charged amount. Hence, in this case, in the first hydrogen station st1, the hydrogen gas is charged up to the charging upper limit value of the tank 30.

When in the first hydrogen station st1, the reservation adjustment portion 222 receives, through the communication portion 250, the pre-processing performance requirement described above, the reservation adjustment portion 222 determines, from a reservation which has already been set and the amount of hydrogen gas stored in the accumulator 264, whether or not a new reservation is able to be made, and when it is determined that a new reservation is able to be made, the reservation adjustment portion 222 notifies the completion of the reservation to the vehicle which transmits the pre-processing performance requirement. The “case where a reservation is able to be made” in the present embodiment includes a case where the number of reservations at the scheduled arrival time at which the fuel cell vehicle 10 reaches the first hydrogen station st1 is less than a predetermined number. The predetermined number described above may be previously set, for example, as such a number of reservations that the arrival at the destination G is not excessively delayed when the hydrogen gas is charged into the fuel cell vehicle 10 after the charging of the hydrogen gas corresponding to the predetermined number of reservations is performed based on a time necessary for the charging of the hydrogen gas per vehicle. The “case where a reservation is able to be made” described above also includes a case where the summed value of a total value of the required charged amount included in the received pre-processing performance requirement and the required charged amount in another reservation which has already been set and the estimated value of an amount charged into a vehicle which visits the first hydrogen station st1 without any reservation so as to charge the hydrogen gas is equal to or less than the current remaining amount of hydrogen in the accumulator 264. The “case where a reservation is able to be made” described above also includes a case where the charging of the hydrogen gas into the fuel cell vehicle 10 is estimated to be completed within the business hours of the first hydrogen station st1 from the scheduled arrival time at which the fuel cell vehicle 10 reaches the first hydrogen station st1 and a completion time at which the charging in another reservation that has already been set is completed. In other words, the case where the number of reservations at the scheduled arrival time is equal to or greater than the predetermined number, the case where the summed value described above is larger than the current remaining amount of hydrogen in the accumulator 264 and the case where it is estimated that the charging of the hydrogen gas into the fuel cell vehicle 10 is not completed within the business hours of the first hydrogen station st1 apply as the “case where a reservation is not able to be made”. Then, in a case where a reservation is able to be made, the reservation adjustment portion 222 sets the reservation received from the navigation device 100. When the pre-processing control portion 224 receives the pre-processing performance requirement, the pre-processing control portion 224 performs processing for making the pre-cooling device 270 perform the pre-processing, that is, processing which operates the refrigerator and the brine circuit so as to cool the brine down to a predetermined temperature such that the pre-cooling processing is able to be started at the scheduled arrival time of the fuel cell vehicle 10. The “estimated value of an amount charged into a vehicle which visits the first hydrogen station st1 without any reservation so as to charge the hydrogen gas” described above may be estimated from, for example, an actual value (history) when the hydrogen gas is charged without any reservation after the time when the reservation is received until the time when the business is completed on another day.

In step S170, the performance requirement transmission portion 124 determines whether or not a reservation is able to be made. As described above, when the performance requirement transmission portion 124 receives, from the closest station, the information indicating that a reservation is able to be made, the performance requirement transmission portion 124 determines that a reservation is able to be made. In this case, the processing is returned to step S105. In step S115 which is thereafter performed, it is determined that the reservation is performed.

When it is determined that a reservation is not able to be made (step S170: no), in step S180, the performance requirement transmission portion 124 determines whether or not another hydrogen station is present as the specific hydrogen station. When it is determined that no other hydrogen station is present (step S180: no), step S130 described above is performed so as to perform the notification processing. On the other hand, when it is determined that another hydrogen station is present (step S180: yes), in step S150, the route setting portion 123 resets a route which passes through another hydrogen station among the specific hydrogen stations. When step S150 is first performed, a route is reset which passes through any one of hydrogen stations other than the closest station among the specific hydrogen stations. For example, among the hydrogen stations other than the closest station in the specific hydrogen stations, the hydrogen station which is the closest from the present location S is identified, and a route which passes through the hydrogen station described above is reset. In step S155, the route setting portion 123 identifies the scheduled arrival time at which the separate hydrogen station identified in step S150 is reached. Step S155 described above is performed as with step S140 described above. In step S160, the performance requirement transmission portion 124 transmits, through the communication portion 60, the pre-processing performance requirement including the required charged amount relative information and the scheduled arrival time to the separate the hydrogen station, and thereby makes a reservation for charging the hydrogen gas. Step S160 described above is performed as with step S145 described above. After the completion of step S160, step S170 described above is performed. When it is determined that in the separate hydrogen station which is first selected in addition to the closest station, a reservation is not able to be reserved (step S170: no), in step S180, whether or not among the specific hydrogen stations, still another hydrogen station which is different from the closest station and the separate hydrogen station described above is present is determined, and when it is determined that still another hydrogen station is present, steps S150 to S160 are performed again.

The hydrogen gas charging reservation processing described above is performed, and thus in the example shown in FIG. 2, instead of the route RT1, the route RT2 is set as the target route of the fuel cell vehicle 10. Hence, the control portion 110 guides the route RT2. When the user drives the fuel cell vehicle 10 according to the route guidance described above and reaches the first hydrogen station st1, the reservation has already been set, and the hydrogen gas is charged into the tank 30 of the fuel cell vehicle 10 according to the reservation described above. Since at the time of the reservation, the pre-processing control portion 224 is instructed to perform the pre-processing, even if the pre-processing is not performed at the time of the reservation, the pre-processing is started before the fuel cell vehicle 10 reaches the first hydrogen station st1. Hence, as compared with a case where the pre-processing is started after the navigation device 100 reaches the first hydrogen station st1, the time necessary until the charging of the hydrogen gas in the first hydrogen station st1 is completed is reduced. Consequently, it is possible to reduce an excessive delay in the time when the fuel cell vehicle 10 reaches the destination G.

In the navigation device 100 of the first embodiment described above, when the distance of the route RT1 is longer than the drivable distance, the target route is changed from the route RT1 to the route RT2 which passes through the first hydrogen station st1, and the pre-processing performance requirement is transmitted to the first hydrogen station st1, with the result that it is possible to increase the possibility that at least part of the pre-processing is completed until the fuel cell vehicle 10 reaches the first hydrogen station st1. Hence, it is possible to reduce the time necessary until the charging of the hydrogen gas is started in the first hydrogen station st1.

Since the performance requirement transmission portion 124 transmits the information on the required charged amount of hydrogen gas to the first hydrogen station st1, in the first hydrogen station st1, based on the information described above, it is possible to make preparations for charging the hydrogen gas such as the acquisition of at least the required charged amount of hydrogen gas.

Since the amount of hydrogen gas which is equal to or greater than a difference between the amount of hydrogen gas obtained by subtracting the amount of hydrogen gas estimated to be required for driving from the present location S to the first hydrogen station st1 from the current remaining amount of hydrogen gas in the tank 30 and the amount of hydrogen gas estimated to be required for driving from the first hydrogen station st1 to the destination G is calculated as the required charged amount and is transmitted to the first hydrogen station st1, the amount of hydrogen gas necessary from the first hydrogen station st1 to the destination G is able to be identified as the required charged amount in the first hydrogen station st1. Hence, in the first hydrogen station st1, it is possible to increase the possibility that at least the amount of hydrogen gas necessary from the first hydrogen station st1 to the destination G is prepared.

When an alternative route (route RT2) to the route RT1 is set, among the specific hydrogen stations, that is, the hydrogen stations present within the range of the drivable distance, a route which passes through the second hydrogen station st2 that is the hydrogen station other than the first hydrogen station st1 and that is the closest from the present location S is set as the alternative route, with the result that it is possible to reduce a problem in which the remaining amount of hydrogen in the tank 30 becomes zero until the hydrogen station is reached.

### B. Second Embodiment

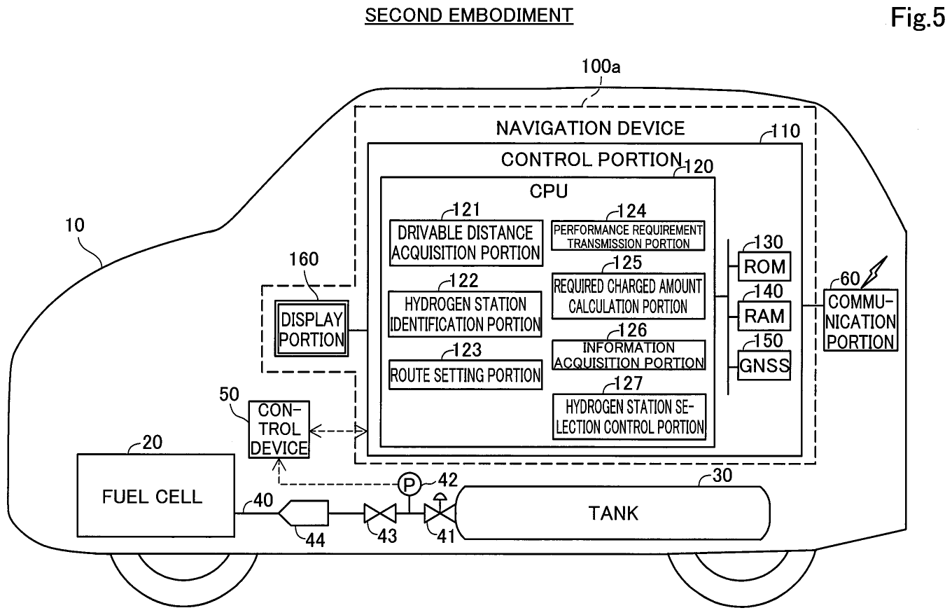

FIG. 5 is a block diagram showing a schematic configuration of a navigation device 100a according to a second embodiment. The navigation device 100a differs from the navigation device 100 of the first embodiment shown in FIG. 1 in that the CPU 120 also functions as an information acquisition portion 126 and a hydrogen station selection control portion 127. Since the other configurations in the navigation device 100a of the second embodiment are the same as those in the navigation device 100 of the first embodiment, the same constituent elements are identified with the same symbols, and thus the detailed description thereof will be omitted. In the second embodiment, the configuration of the fuel cell vehicle 10 is the same as that of the fuel cell vehicle 10 in the first embodiment.

The information acquisition portion 126 acquires charging status relative information from the hydrogen station. The details of the charging status relative information will be described later. The hydrogen station selection control portion 127 displays the charging status relative information on the display portion 160 so as to associate the charging status relative information with the hydrogen station, and receives an operation of selecting the hydrogen station. The details of processing which is performed with the hydrogen station selection control portion 127 will be described later.

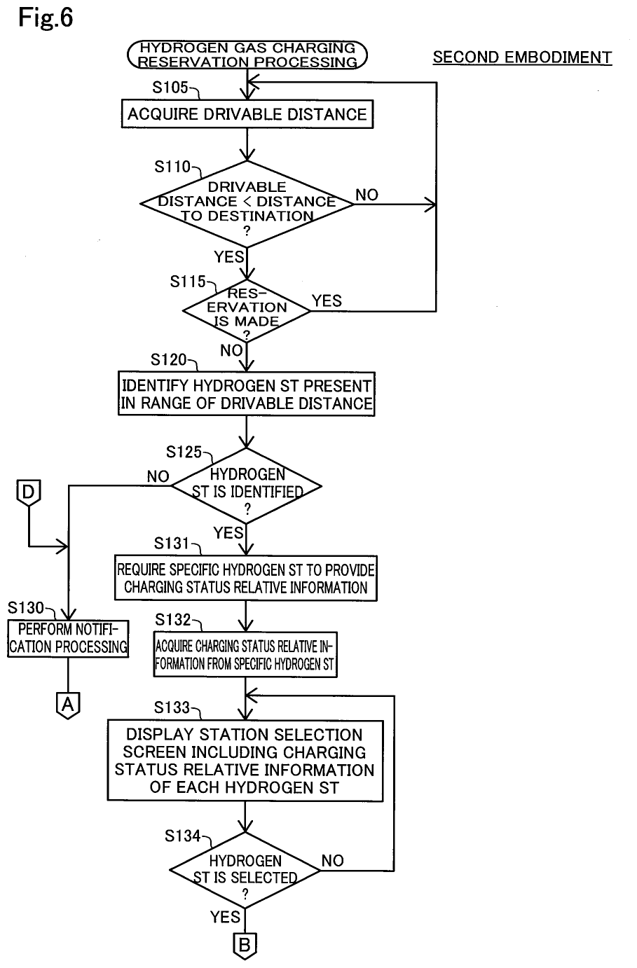

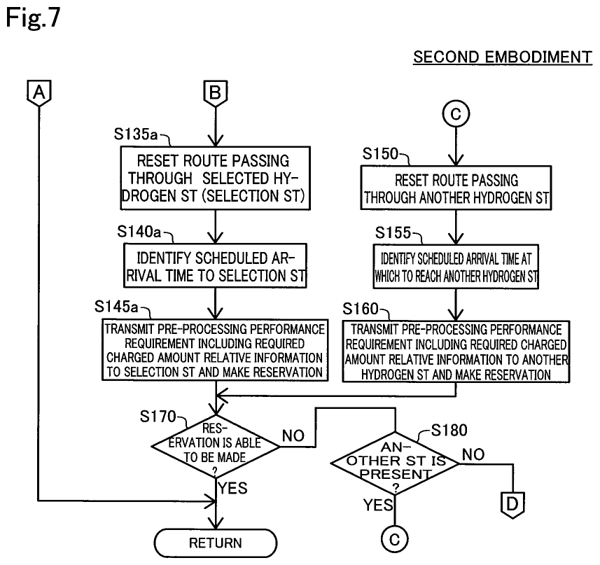

FIGS. 6 and 7 are flowcharts showing a procedure for hydrogen gas charging reservation processing in the second embodiment. The hydrogen gas charging reservation processing in the second embodiment differs from the hydrogen gas charging reservation processing of the first embodiment shown in FIG. 4 in that steps S131 to S134 are additionally performed and that instead of steps S135, S140 and S145, steps S135a, S140a and S145a are performed. Since the other procedure for the hydrogen gas charging reservation processing in the second embodiment is the same as that for the hydrogen gas charging reservation processing in the first embodiment, the same procedural steps are identified with the same symbols, and thus the detailed description thereof will be omitted.

As shown in FIG. 6, when in step S125, it is determined that a hydrogen station is identified (step S125: yes), in step S131, the information acquisition portion 126 requires, through the communication portion 60, the specific hydrogen station to provide the charging status relative information. The charging status relative information means information related to the status of the charging of the hydrogen gas in the hydrogen station. In the present embodiment, the charging status relative information includes charging convenience information, the group name of a group to which the hydrogen station belongs and the unit selling price of the hydrogen gas.

The “charging convenience information” is information which indicates the convenience of the charging of the hydrogen gas, and includes information on an expected waiting time and information on the amount of hydrogen gas which is able to be charged. The “information on an expected waiting time” means information related to an expected waiting time after the fuel cell vehicle 10 reaches the hydrogen station until the start of the charging of the hydrogen gas. In the present embodiment, as the information on the expected waiting time, the number of reservations for charging the hydrogen gas which have already been made and the business hours of the hydrogen station apply. When the number of reservations for charging the hydrogen gas is large, the expected waiting time is increased. When the scheduled arrival time at which the fuel cell vehicle 10 reaches the hydrogen station exceeds the business hours of the hydrogen station, it is necessary to wait until a business start time on the next business day. The “information on the amount of hydrogen gas which is able to be charged” means information related to the upper limit amount of hydrogen gas which is able to be charged when the hydrogen gas is charged after the fuel cell vehicle 10 reaches the hydrogen station. In the present embodiment, as the information on the amount of hydrogen gas which is able to be charged, the number of reservations for charging the hydrogen gas and the amount of hydrogen gas stored apply. In a case where the number of reservations for charging the hydrogen gas is larger, when the fuel cell vehicle 10 reaches the hydrogen station so as to charge the hydrogen gas, it is likely that the stored amount in the hydrogen station is smaller and that the upper limit amount of hydrogen gas which is able to be charged is more decreased. Likewise, when the amount of hydrogen gas stored is smaller, it is likely that the upper limit amount of hydrogen gas which is able to be charged is more decreased.

When in the hydrogen station, the reservation adjustment portion 222 receives the requirement of the charging status relative information from the fuel cell vehicle 10, the reservation adjustment portion 222 acquires the charging status relative information and transmits it to the fuel cell vehicle 10.

In the fuel cell vehicle 10, the information acquisition portion 126 receives and acquires, in step S132, the charging status relative information from each of the specific hydrogen stations. In the example of FIG. 2, the information acquisition portion 126 acquires the charging status relative information from each of the two hydrogen stations st1 and st2. In step S133, the hydrogen station selection control portion 127 displays, on the display portion 160, a hydrogen station selection screen including the acquired charging status relative information.

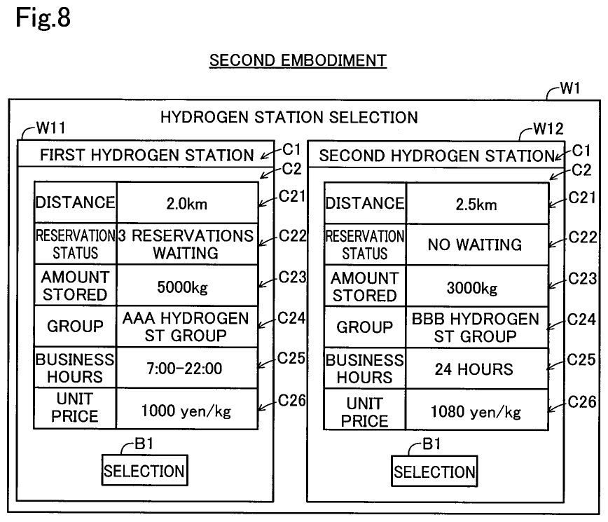

FIG. 8 is an illustrative view showing an example of the hydrogen station selection screen W1. The hydrogen station selection screen W1 includes station detailed windows W11 and W12. The station detailed window W11 is a window for the first hydrogen station st1. The station detailed window W12 is a window for the second hydrogen station st2. Each of the station detailed windows W11 and W12 includes display portions C1 and C2 for displaying various types of information including the charging status relative information of the individual hydrogen stations and a selection button B1.

The display portion C1 displays the name of the hydrogen station. The display portion C2 includes six sub-display portions C21 to C26. The sub-display portion C21 displays a distance from the present location S to the hydrogen station. The sub-display portion C22 displays the number of reservations for charging the hydrogen gas in the hydrogen station. The sub-display portion C23 displays the amount of hydrogen gas stored in the hydrogen station. The sub-display portion C24 displays the group name of a group to which the hydrogen station belongs. The sub-display portion C25 displays the business hours of the hydrogen station. The sub-display portion C26 displays the unit selling price of the hydrogen gas. The user browses or compares various types of information displayed on the display portions C1 and C2 so as to be able to select the hydrogen station for charging the hydrogen gas. The selection button B1 is a button for receiving the selection.

As shown in FIG. 6, in step S134, the hydrogen station selection control portion 127 determines whether or not the hydrogen station for charging the hydrogen gas is selected. When it is determined that the hydrogen station is not selected (step S134: no), the processing is returned to step S133. On the other hand, when it is determined that the hydrogen station is selected (step S134: yes), as shown in FIG. 7, in step S135a, the route setting portion 123 resets, as the target route of the fuel cell vehicle 10, a route which passes through the selected hydrogen station (hereinafter referred to as the “selection station”).

In step S140a, the route setting portion 123 identifies the scheduled arrival time at which the selection station is reached. In step S145a, the performance requirement transmission portion 124 transmits, through the communication portion 60, the pre-processing performance requirement including the required charged amount relative information and the scheduled arrival time to the selection station, and thereby reserves the charging of the hydrogen gas. After the completion of step S145a, step S170 described above is performed.

In the navigation device 100a of the second embodiment described above, the charging status relative information in the individual hydrogen stations present within the range Ar1 of the drivable distance is displayed on the display portion 160, and thus based on the information described above, the user is able to select the hydrogen station for charging the hydrogen gas.

The charging status relative information includes the information on the expected waiting time, the information on the amount of hydrogen gas which is able to be charged and the charging convenience information indicating the convenience of the charging of the hydrogen gas, and thus the user is able to select, based on the charging convenience information, as the hydrogen station for charging the hydrogen gas, a convenient hydrogen station such as a hydrogen station in which the expected waiting time is short or a hydrogen station which is able to charge a sufficient amount of hydrogen gas in order for the fuel cell vehicle to reach the destination S because the amount of hydrogen gas which is able to be charged is large. The information on the expected waiting time includes the number of reservations for charging the hydrogen gas which have already been made and the business hours of the hydrogen station, and thus the user is able to estimate, based on the number of reservations for charging the hydrogen gas which have already been made, whether the expected waiting time is long or short, and the user is also able to determine, based on the business hours of the hydrogen station, whether or not it is necessary to wait until a business start time on the next business day.

The charging status relative information includes the group name of a group to which the hydrogen station belongs and the unit selling price of the hydrogen gas, and thus the user is able to select, as the hydrogen station for charging the hydrogen gas, for example, a hydrogen station which belongs to a group having a member card or a hydrogen station in which the unit selling price is more inexpensive.

### C. Other Embodiments

(C1) Although in each of the embodiments, the required charged amount relative information is included in the pre-processing performance requirement, the required charged amount relative information may be omitted. In the configuration described above, when whether or not a reservation is able to be made is determined, the amount of hydrogen gas charged may be estimated as a fixed value. In the configuration described above, the maximum amount which is able to be charged in each type of vehicle may be set as a fixed value. In this way, it is possible to reduce, with a high probability, the setting of a reservation for charging the hydrogen gas which exceeds the amount of hydrogen gas stored. Although the scheduled arrival time is included in the pre-processing performance requirement, the present disclosure is not limited to this configuration. Instead of the scheduled arrival time or in addition to the scheduled arrival time, the name of the manufacturer of the fuel cell vehicle 10, the model number of the vehicle and information on a desired method of paying the price such as the information of the company name of a credit card may be included. These types of information are included in the required charged amount relative information, and thus the hydrogen station is able to previously identify these types of information. Hence, when a plurality of dispensers are prepared according to the type of vehicle and the payment method, it is possible to previously reserve with which one of the dispensers the hydrogen gas is charged.

(C2) Although in each of the embodiments, the required charged amount relative information and the scheduled arrival time are included in the pre-processing performance requirement, these types of information may be transmitted to the hydrogen station as information which is separate from the pre-processing performance requirement. In other words, when the pre-processing performance requirement is transmitted, the required charged amount relative information or information on the scheduled arrival time may be transmitted separately from the requirement described above. In the configuration described above, the pre-processing performance requirement may be omitted. In other words, the required charged amount relative information and the information on the scheduled arrival time may be transmitted to the hydrogen station, and special information serving as the “pre-processing performance requirement” does not need to be transmitted. In the configuration described above, the hydrogen station receives the required charged amount relative information and the information on the scheduled arrival time, and thus it is possible to recognize that the performance of the pre-processing is required. In other words, in the configuration described above, the “transmission of the required charged amount relative information and the information on the scheduled arrival time” corresponds to the performance requirement of the pre-processing in the present disclosure.

(C3) Although in the second embodiment, the charging convenience information includes the information on the expected waiting time and the information on the amount of hydrogen gas which is able to be charged, the charging convenience information does not need to include either of them. Although as the information on the expected waiting time, the number of reservations for charging the hydrogen gas which have already been made and the business hours of the hydrogen station apply, either of these types of information may be omitted. Although as the information on the amount of hydrogen gas which is able to be charged, the number of reservations for charging the hydrogen gas and the amount of hydrogen gas stored apply, either of these types of information may be omitted. As the information on the amount of hydrogen gas which is able to be charged, instead of at least one of the number of reservations for charging the hydrogen gas and the amount of hydrogen gas stored, the amount of hydrogen gas described below may apply. For example, the amount of hydrogen gas obtained by subtracting the amount of hydrogen gas estimated to be charged by reservations which have already been made from the current amount of hydrogen gas stored may apply. For example, the amount of hydrogen gas obtained by subtracting the amount of hydrogen gas estimated to be charged by reservations which have already been made and the amount of hydrogen gas estimated to be charged without any reservation until the scheduled arrival time of the fuel cell vehicle 10 from the current amount of hydrogen gas stored may apply. The “amount of hydrogen gas estimated to be charged by reservations which have already been made” may be calculated, for example, by referencing the history so as to determine the average value of the amounts of hydrogen gas charged by individual reservations and multiplying the average value by the number of reservations which have already been made. Likewise, the “amount of hydrogen gas estimated to be charged without any reservation until the scheduled arrival time of the fuel cell vehicle 10” may be calculated by referencing the history so as to determine the average value of the amounts of hydrogen gas charged per unit time without any reservation and multiplying, by the average value, a value obtained by dividing the time until the scheduled arrival time by the unit time.

(C4) Although in the second embodiment, the charging status relative information includes the charging convenience information, the group name of a group to which the hydrogen station belongs and the unit selling price of the hydrogen gas, the present disclosure is not limited to this configuration. At least one of these types of information may be omitted. Instead of at least one of these types of information, information on a method of paying the price, information on ancillary services such as information indicating that a restaurant and a hotel are additionally provided and the like may be included.

(C5) Although in each of the embodiments, the required charged amount is calculated as the amount of hydrogen gas obtained by adding a predetermined additional gas amount to a difference between the amount of hydrogen gas obtained by subtracting the amount of hydrogen gas estimated to be required from the present location S to the first hydrogen station st1 from the current remaining amount of hydrogen gas in the tank 30 and the amount of hydrogen gas estimated to be required for driving from the first hydrogen station st1 to the destination G, the present disclosure is not limited to this configuration.

Only the difference described above is calculated as the required charged amount, and the predetermined additional gas amount described above does not need to be added. In the configuration described above, it is possible to reach at least the destination G. Although the predetermined additional gas amount is the predetermined fixed value, a configuration may be adopted in which the user is able to make a selection. For example, a configuration may be adopted in which a menu screen for selecting the additional gas amount is displayed on the display portion 160 and in which the user is made to input, from the menu screen, an additional gas amount desired by the user.

(C6) Although in each of the embodiments, the drivable distance is calculated with the control device 50 included in the fuel cell vehicle 10, instead of the control device 50, the drivable distance may be calculated with the navigation device 100 or 100a. Although in each of the embodiments, the required charged amount is calculated with the required charged amount calculation portion 125, instead of the required charged amount calculation portion 125, the required charged amount may be calculated with the control device 50.

(C7) Although in each of the embodiments, each of the hydrogen stations st1 to st3 stores hydrogen in the state of hydrogen gas (gas), the present disclosure is not limited to this configuration. A configuration may be adopted in which hydrogen is stored in the state of liquid hydrogen (liquid), in which the liquid hydrogen is vaporized on-site to generate hydrogen gas and in which the hydrogen gas is stored. In the configuration described above, each of the hydrogen stations st1 to st3 includes a storage chamber, a vaporizer and the like of liquid hydrogen. In the configuration described above, processing which vaporizes liquid hydrogen in addition to the pre-cooling processing corresponds to the pre-processing in the present disclosure. Hence, in the configuration described above, in the hydrogen station which receives the pre-processing performance requirement, the pre-cooling processing and the vaporization processing are performed such that at the scheduled arrival time at which the fuel cell vehicle 10 reaches the hydrogen station, the charging of the hydrogen gas into the fuel cell vehicle 10 is able to be started. A configuration may be adopted in which as the pre-processing, only the vaporization processing is performed without the pre-cooling processing being performed. Regardless of the pre-cooling processing and the vaporization processing, arbitrary processing which is previously performed in order to charge the hydrogen gas corresponds to the pre-processing in the present disclosure.

(C8) Although in each of the embodiments, the navigation device 100 or 100a includes the display portion 160, the display portion 160 may be omitted. In the configuration described above, various types of information such as the hydrogen station selection screen W1 in the second embodiment may be displayed on a display device such as a touch panel installed in the instrument panel of the fuel cell vehicle 10.

(C9) Although in each of the embodiments, the control device 50 calculates the drivable distance based on the remaining amount of hydrogen from the average vehicle speed and the amount of hydrogen consumed after the startup of the fuel cell vehicle 10 until now, the present disclosure is not limited to this configuration. A configuration may be adopted in which the initial value of the drivable distance is calculated when the hydrogen gas is charged into the tank 30, in which thereafter each time the fuel cell vehicle 10 drives, the driving distance is sequentially subtracted and in which thus the current drivable distance is calculated. Alternatively, a configuration may be adopted in which the amount of hydrogen gas charged into the tank 30 is identified when the hydrogen gas is charged, in which thereafter each time the fuel cell vehicle 10 generates power, the amount of power generation is recorded, in which the amount of hydrogen gas consumed is determined from the amount of power generation by computation using a predetermined computation formula or by referencing a predetermined map, in which the amount of hydrogen gas consumed is subtracted from the charged hydrogen gas, in which thus the remaining amount of hydrogen is identified and in which the drivable distance is calculated based on the remaining amount of hydrogen that is obtained.

(C10) In the first embodiment, among the specific hydrogen stations, the closest hydrogen station is the first candidate for the hydrogen station which charges the hydrogen gas. In the second embodiment, the selection hydrogen station which is selected by the user is the first candidate for the hydrogen station which charges the hydrogen gas. However, the present disclosure is not limited to these configurations. For example, “among the specific hydrogen stations, a hydrogen station in which an increase from a distance from the present location S through the hydrogen station to the destination G to a distance without the hydrogen station being passed through, that is, the distance of the route RT1 is minimized” may be the first candidate for the hydrogen station which charges the hydrogen gas. In the configuration described above, it is possible to reduce the total amount of hydrogen gas necessary until the destination G is reached from the present location S. For example, “among the specific hydrogen stations, a hydrogen station in which a distance from the hydrogen station to the destination G is the shortest” may be the first candidate for the hydrogen station which charges the hydrogen gas. In the configuration described above, it is possible to reduce the occurrence of conditions in which the remaining amount of hydrogen gas when the hydrogen station is reached is excessively large. Hence, it is possible to reduce a problem where although the hydrogen station is reached, since the amount of hydrogen with which the tank 30 is able to be replenished, that is, the empty capacity of the tank 30 is low, the amount of hydrogen gas runs out again on the way to the destination G after the tank 30 is replenished with the hydrogen gas. In each of the embodiments, when as described above, the amount of hydrogen gas runs out again on the way to the destination G after the tank 30 is replenished with the hydrogen gas, a drivable range with reference to the driving position at that time is identified again, a hydrogen station present within the drivable range is identified and thus the target route is changed to a route which passes through the hydrogen station described above.

(C11) When in each of the embodiments, it is determined that a hydrogen station is identified within the drivable range (step S125: yes), only processing which transmits the pre-processing requirement to the specific hydrogen station may be performed, and the other processing may be omitted. In the configuration described above, regardless of whether or not there is a possibility of a reservation or regardless of whether or not to be present on the target route after being changed, the pre-processing requirement is transmitted to all the specific hydrogen stations. In the configuration described above, when the fuel cell vehicle 10 reaches any one of the hydrogen stations, it is possible to increase the possibility that at least part of the pre-processing is completed.

(C12) When in each of the embodiments, in the hydrogen station which receives the pre-processing performance requirement, the reservation adjustment portion 222 determines whether or not a reservation is able to be made, the determination may be made with consideration given to the scheduled arrival time of the fuel cell vehicle 10 and a pre-processing completion time. Specifically, a configuration may be adopted in which when the scheduled arrival time of the fuel cell vehicle 10 is later than the pre-processing completion time, it is determined that “a reservation is able to be made” whereas when the scheduled arrival time of the fuel cell vehicle 10 is earlier than the pre-processing completion time, it is determined that “a reservation is not able to be made”.

(C13) In the second embodiment, instead of a selection of the hydrogen station being made by the user, based on the charging status relative information which is acquired, the CPU 120 may make a selection. Specifically, a configuration may be adopted in which a rule for determining priorities based on the charging status relative information is previously set, in which priorities are determined according to the rule and in which thus a hydrogen station with the highest priority is selected as the hydrogen station for charging the hydrogen gas. For example, a configuration may be adopted in which points corresponding to the values of the individual items of the charging convenience information are determined, in which all the points determined are summed so as to be set to the priority and in which a hydrogen station with the highest priority, that is, with the highest total value is selected as the hydrogen station for charging the hydrogen gas.

(C14) In each of the embodiments, part of a configuration realized by hardware may be replaced by software whereas part of a configuration realized by software may be replaced by hardware. For example, at least one function portion of the drivable distance acquisition portion 121, the hydrogen station identification portion 122, the route setting portion 123, the performance requirement transmission portion 124, the required charged amount calculation portion 125, the information acquisition portion 126 and the hydrogen station selection control portion 127 may be realized with an integrated circuit, a discrete circuit or a module in which these circuits are combined together. When part or the whole of functions in the present disclosure are realized by software, the software (computer programs) are able to be provided in the form of being stored in a computer readable recording medium. The “computer readable recording medium” is not limited to portable recording media such as a flexible disk and a CD-ROM, and includes various types of internal storage devices within a computer such as a RAM and a ROM, or external storage devices fixed in a computer such as a hard disk. In other words, the “computer readable recording medium” has a broad meaning which includes an arbitrary recording medium that is able to fix data packets not temporarily but permanently.

The present disclosure is not limited to the embodiments described above, and is able to be realized with various configurations without departing from the spirit thereof. For example, technical features in the embodiments corresponding to the technical features in the aspects described in the section of SUMMARY are able to be replaced with each other or combined together as necessary in order to solve part or the whole of the problems described previously or to achieve part or the whole of the effects described previously. When the technical features are not described as essential features in the present specification, they are able to be deleted as necessary. For example, the present disclosure may be realized with embodiments which will be described below.

(1) According to one aspect of the present disclosure, a navigation device is provided that is mounted on a fuel cell vehicle including a fuel cell which uses hydrogen gas as a fuel gas and is used and that performs route guidance for the fuel cell vehicle. The navigation device includes: a drivable distance acquisition portion configured to acquire a drivable distance over which the fuel cell vehicle is able to drive without being replenished with the hydrogen gas; a hydrogen station identification portion configured to identify a hydrogen station present within a drivable range that is a range from a present location to the drivable distance; a route setting portion configured to set a target route that is a route from the present location to a destination and to change, when the distance of a first route which is the target route set according to a predetermined condition is longer than the drivable distance, the target route to a second route which passes through a specific hydrogen station serving as the identified hydrogen station and that is different from the first route; and a performance requirement transmission portion configured to transmit, to the specific hydrogen station, through a communication portion mounted on the fuel cell vehicle, a performance requirement of pre-processing for charging the hydrogen gas into a hydrogen gas storage portion included in the fuel cell vehicle.

In the navigation device of this embodiment, when the distance of the first route is longer than the drivable distance, the target route is changed to the second route that passes through the specific hydrogen station, and the performance requirement of the pre-processing for charging the hydrogen gas is transmitted to the specific hydrogen station, with the result that it is possible to increase the possibility that at least part of the pre-processing is completed until the fuel cell vehicle reaches the hydrogen station. Hence, it is possible to reduce the time necessary until the charging of the hydrogen gas is started in the hydrogen station.

(2) In the navigation device of the embodiment described above, the performance requirement transmission portion may transmit, when transmitting the performance requirement of the pre-processing to the specific hydrogen station, information on a required charged amount of the hydrogen gas.

In the navigation device of this embodiment, since the performance requirement transmission portion transmits, when transmitting the performance requirement of the pre-processing to the specific hydrogen station, the information on the required charged amount of hydrogen gas, in the specific hydrogen station, based on the information described above, it is possible to make preparations for charging the required charged amount of hydrogen gas such as the acquisition of the required charged amount of hydrogen gas.

(3) The navigation device of the embodiment described above may further include: an information acquisition portion configured to acquire, when a plurality of the specific hydrogen stations are identified within the drivable range, charging status relative information related to the status of charging of the hydrogen gas from each of the specific hydrogen stations through the communication portion; and a hydrogen station selection control portion configured to display the charging status relative information on a display portion so as to associate the charging status relative information with each of the specific hydrogen stations, and to receive an operation of selecting, among the specific hydrogen stations, the hydrogen station for charging the hydrogen gas.

In the navigation device of this embodiment, the charging status relative information is displayed for each of the identified specific hydrogen stations, and it is possible to receive the operation of selecting the hydrogen station for charging the hydrogen gas, with the result that a user references the charging status relative information which is displayed so as to be able to select the hydrogen station for charging the hydrogen gas.

(4) In the navigation device of the embodiment described above, the charging status relative information may include charging convenience information that indicates the convenience of the charging of the hydrogen gas and that includes at least one of information on an expected waiting time and information on the amount of the hydrogen gas which is able to be charged.

In the navigation device of this embodiment, the charging status relative information includes at least one of the information on the expected waiting time and the information on the amount of hydrogen gas which is able to be charged and the charging convenience information indicating the convenience of the charging of the hydrogen gas, and thus the user is able to select, based on the charging convenience information, as the hydrogen station for charging the hydrogen gas, a convenient hydrogen station such as a hydrogen station in which the expected waiting time is short or a hydrogen station which is able to charge a sufficient amount of hydrogen gas in order for the fuel cell vehicle to reach the destination because the amount of hydrogen gas which is able to be charged is large.

(5) In the navigation device of the embodiment described above, the information on the expected waiting time may include at least one of the number of reservations that have already been made and the business hours of the specific hydrogen station.

In the navigation device of this embodiment, the information on the expected waiting time includes at least one of the number of reservations which have already been made and the business hours of the specific hydrogen station, and thus when the number of reservations which have already been made is included, the user is able to estimate the expected waiting time from the number of reservations whereas when the business hours of the specific hydrogen station are included, the user is also able to determine whether or not it is necessary to wait until a business start time on the next business day.

(6) In the navigation device of the embodiment described above, the information on the amount of the hydrogen gas that is able to be charged may include information indicating at least one of a current amount stored which is the current amount of the hydrogen gas stored in the specific hydrogen station and the amount of the hydrogen gas obtained by subtracting, from the current amount stored, a reservation estimation charged amount serving as the amount of the hydrogen gas estimated to be charged by the reservations which have already been made.

In the navigation device of this embodiment, the information on the amount of hydrogen gas that is able to be charged includes the information indicating at least one of the current amount stored in the hydrogen station and the amount of hydrogen gas obtained by subtracting the reservation estimation charged amount from the current amount stored, and thus the user is able to highly accurately select, based on the information thereof, as the hydrogen station for charging the hydrogen gas, the hydrogen station which is able to charge a sufficient amount of hydrogen gas in order for the fuel cell vehicle to reach the destination because the amount of hydrogen gas which is able to be charged is large.

(7) In the navigation device of the embodiment described above, the performance requirement transmission portion may notify, when transmitting the performance requirement of the pre-processing to the specific hydrogen station, a scheduled arrival time at which the fuel cell vehicle reaches the specific hydrogen station, and the information on the amount of the hydrogen gas that is able to be charged may include information indicating the amount of the hydrogen gas obtained by subtracting, from the current amount stored which is the current amount of the hydrogen gas stored in the specific hydrogen station, the amount of the hydrogen gas estimated to be charged by the reservations which have already been made and the amount of the hydrogen gas estimated to be charged without any reservation until the scheduled arrival time.

In the navigation device of this embodiment, the information on the amount of hydrogen gas that is able to be charged includes the information indicating the amount of the hydrogen gas obtained by subtracting, from the current amount stored in the specific hydrogen station, the amount of the hydrogen gas estimated to be charged by the reservations which have already been made and the amount of the hydrogen gas estimated to be charged without any reservation until the scheduled arrival time, and thus the user is able to highly accurately select, based on the information thereof, as the hydrogen station for charging the hydrogen gas, the hydrogen station which is able to charge a sufficient amount of hydrogen gas in order for the fuel cell vehicle to reach the destination because the amount of hydrogen gas which is able to be charged is large.

The present disclosure may be realized with various embodiments. For example, the present disclosure is able to be realized with embodiments such as a hydrogen gas charging reservation system, a route selection system, a hydrogen station selection system, a fuel cell vehicle, a route guidance method, a route selection method, a hydrogen gas charging reservation method, a hydrogen station selection method, computer programs for realizing these devices and methods and storage media which store the computer programs described above.

What is claimed is:

1. A navigation device that is mounted on a fuel cell vehicle including a fuel cell which uses hydrogen gas as a fuel gas and is used and that performs route guidance for the fuel cell vehicle, the navigation device comprising:
a drivable distance acquisition portion configured to acquire a drivable distance over which the fuel cell vehicle is able to drive without being replenished with the hydrogen gas;
a hydrogen station identification portion configured to identify a hydrogen station present within a drivable range that is a range from a present location to the drivable distance;
a route setting portion configured to set a target route that is a route from the present location to a destination and to change, when a distance of a first route which is the target route set according to a predetermined condition is longer than the drivable distance, the target route to a second route which passes through a specific hydrogen station serving as the identified hydrogen station and that is different from the first route; and
a performance requirement transmission portion configured to transmit, to the specific hydrogen station, through a communication portion mounted on the fuel cell vehicle, a performance requirement of pre-processing for charging the hydrogen gas into a hydrogen gas storage portion included in the fuel cell vehicle.

2. The navigation device according to claim 1,
wherein the performance requirement transmission portion transmits, when transmitting the performance requirement of the pre-processing to the specific hydrogen station, information on a required charged amount of the hydrogen gas.

3. The navigation device according to claim 1, further comprising:
an information acquisition portion configured to acquire, when a plurality of the specific hydrogen stations are identified within the drivable range, charging status relative information related to a status of charging of the hydrogen gas from each of the specific hydrogen stations through the communication portion; and
a hydrogen station selection control portion configured to display the charging status relative information on a display portion so as to associate the charging status relative information with each of the specific hydrogen stations, and to receive an operation of selecting, among the specific hydrogen stations, the hydrogen station for charging the hydrogen gas.

4. The navigation device according to claim 3,
wherein the charging status relative information includes charging convenience information that indicates convenience of the charging of the hydrogen gas and that includes at least one of information on an expected waiting time and information on an amount of the hydrogen gas which is able to be charged.

5. The navigation device according to claim 4,
wherein the information on the expected waiting time includes at least one of a number of reservations that have already been made and business hours of the specific hydrogen station.

6. The navigation device according to claim 4,
wherein the information on the amount of the hydrogen gas that is able to be charged includes information indicating at least one of a current amount stored which is a current amount of the hydrogen gas stored in the specific hydrogen station and an amount of the hydrogen gas obtained by subtracting, from the current amount stored, a reservation estimation charged amount serving as an amount of the hydrogen gas estimated to be charged by the reservations which have already been made.

7. The navigation device according to claim 4,
wherein the performance requirement transmission portion notifies, when transmitting the performance requirement of the pre-processing to the specific hydrogen station, a scheduled arrival time at which the fuel cell vehicle reaches the specific hydrogen station, and
the information on the amount of the hydrogen gas that is able to be charged includes information indicating an amount of the hydrogen gas obtained by subtracting, from the current amount stored which is the current amount of the hydrogen gas stored in the specific hydrogen station, the amount of the hydrogen gas estimated to be charged by the reservations which have already been made and an amount of the hydrogen gas estimated to be charged without any reservation until the scheduled arrival time.

8. A route guidance method for a fuel cell vehicle including a fuel cell which uses hydrogen gas as a fuel gas, the route guidance method comprising:
acquiring a drivable distance over which the fuel cell vehicle is able to drive without being replenished with the hydrogen gas;
identifying a hydrogen station present within a drivable range which is a range from a present location to the drivable distance;
setting a target route that is a route from the present location to a destination and changing, when a distance of a first route that is the target route set according to a predetermined condition is longer than the drivable distance, the target route to a second route which passes through a specific hydrogen station serving as the identified hydrogen station and that is different from the first route; and
transmitting, to the specific hydrogen station, through a communication portion mounted on the fuel cell vehicle, a performance requirement of pre-processing for charging the hydrogen gas into a hydrogen gas storage portion included in the fuel cell vehicle.
